(19) United States
(12) Patent Application Publication
(10) Pub. No.: US 2006/0178798 A1
(43) Pub. Date: Aug. 10, 2006

(54) Method for detecting vehicle speed

(75) Inventor: Stephen Chen, Changhua (TW)

Correspondence Address: BRUCE H. TROXELL;SUITE 1404, 5205 LEESBURG PIKE, FALLS CHURCH, VA, 22041, US

(73) Assignee: E-Lead Electronics Co., Ltd.

(21) Appl. No.: 11/050,870

(22) Filed: Feb. 7, 2005

(51) Int. Cl. G06F 19/00

(52) U.S. Cl. 701/70; 702/141; 702/142

(57) ABSTRACT

A method for detecting vehicle speed detects existing noise frequency of vehicle power supply and vehicle acceleration value, and compares and processes the detected data to estimate the final vehicle speed. The method includes the procedure of (1) detecting power supply noise frequency and converting to engine speed; (2) detecting acceleration value; (3) comparing the engine speed and the vehicle speed; and (4) selecting the final vehicle speed. By means of the procedure of the invention, the vehicle speed may be provided to the vehicle navigation apparatus to continuously perform navigation during the brief period when the GPS signals are lost.

### BACKGROUND OF THE INVENTION

1. Field of the Invention

The invention relates to a method for detecting vehicle speed that measures vehicle power supply noise frequency and vehicle acceleration value and incorporates vehicle driving conditions to derive a final vehicle speed to provide a vehicle navigation apparatus to continuously perform vehicle navigation during a period when GPS signals are absent.

2. Description of the Prior Art

Satellite-based vehicle navigation system has become quite popular nowadays. Through signals transmitted by positioning satellites, the location of a vehicle may be positioned on an electronic map and displayed instantly. By entering a destination, a desired driving route may be derived to direct the driver. However, due to geographic conditions or roads and buildings, poor or interrupted signals often occur. For instance, driving in a tunnel, under an overpass, or in the alleys bordered by high rise buildings, the vehicle navigation apparatus could become dysfunction because the satellite signals cannot be properly received. To remedy this problem, some high end navigation apparatus 11 as shown in FIG. 1 use a gyroscope 12 and a vehicle speed line 13 to derive the location of a driving vehicle to compensate the lost satellite signal 14 for the navigation apparatus 11. However, the location of vehicle speed line and signal format are different on different vehicles, this results in installation difficulty. Many users purchase high end navigation devices but cannot install by themselves.

### SUMMARY OF THE INVENTION

In view of the aforesaid problems such as the navigation device becomes ineffective when GPS signals are lost, and vehicle speed line has different specifications and is difficult to install, the present invention provides a method for detecting vehicle speed that includes the procedure of: (1) detecting power supply noise frequency and converting to engine speed; (2) detecting acceleration value; (3) comparing the engine speed and the vehicle speed; and (4) selecting the final vehicle speed. Through the procedure set forth above, the vehicle speed may be derived to enable the navigation apparatus to continuously perform navigation even the GPS signals are lost in a brief period.

In one aspect, the method of the invention to detect the vehicle power supply noise frequency mainly employs a vehicle speed detection apparatus which includes at least a vehicle power supply noise detection unit.

In another aspect, the vehicle speed detection unit includes an accelerometer to detect the acceleration value of the vehicle.

In yet another aspect, the vehicle speed detection unit gets the vehicle power supply noise frequency by plugging in the vehicle lighter jack which is connected to the power supply so that the vehicle speed detection apparatus and the navigation apparatus can obtain required power supply easily.

The invention provides a solution to overcome the problems of dysfunction occurred to the conventional vehicle navigation devices when the GPS signals are lost in a brief period, and varying specifications of vehicle speed line and installation difficulty. By providing vehicle speed without the vehicle speed line, the final vehicle speed of a driving vehicle may be derived accurately to meet the requirement of the navigation system, and users can enjoy the plug and use convenience.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a conventional vehicle navigation system.

FIG. 2 is a circuit block diagram of the invention

FIG. 3 is a chart showing the characteristic relationship between the engine speed and vehicle speed according to the invention.

FIG. 4 is a vehicle speed table relating to the gearshift and engine speed according to the invention.

FIG. 5 is the main flowchart of the invention.

FIG. 6 is the flowchart of step S2 of the invention.

FIG. 7 is the flowchart of step S3 of the invention.

FIGS. 8A and 8B are the flowchart of step S4 of the invention.

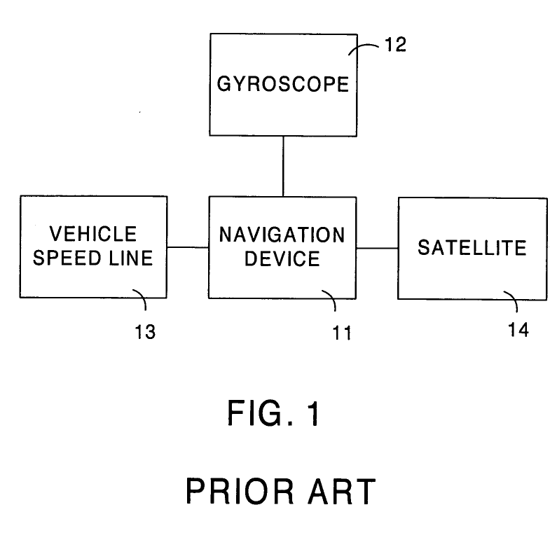

### DESCRIPTION OF THE PREFERRED EMBODIMENTS

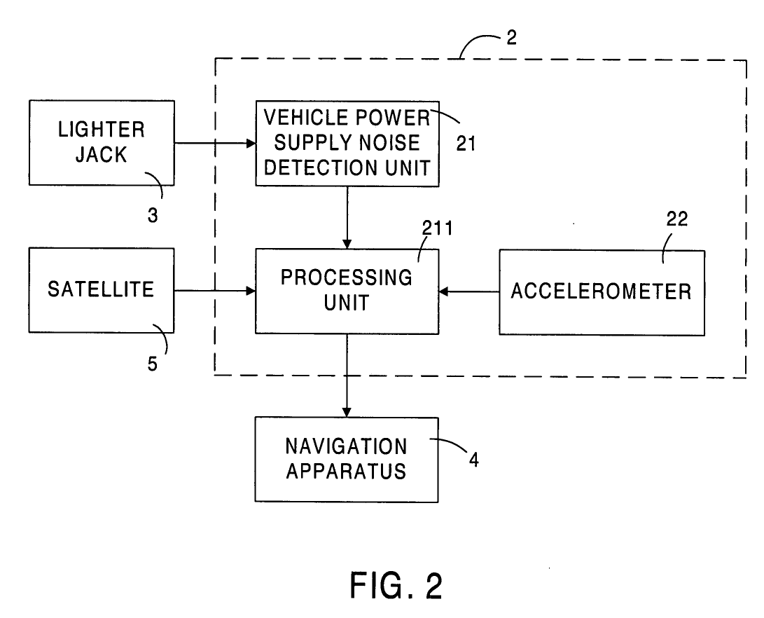

Refer to FIG. 2 for a circuit block diagram of a vehicle speed detection apparatus 2 for detecting vehicle power supply noise frequency. It includes a vehicle power supply noise detection unit 21 and an accelerometer 22.

The vehicle power supply noise detection unit 21 aims to detect the noise frequency (NF) of the existing vehicle power supply and convert to engine speed (ES).

The accelerometer 22 aims to detect a vehicle acceleration value a.

The vehicle speed detection apparatus 2 further includes a processing unit 211 to receive satellite signals from a satellite 5, engine speed signals converted by the vehicle power supply noise detection unit 21 and the signal of the vehicle acceleration value a of the accelerometer 22, and process and compare the aforesaid signals.

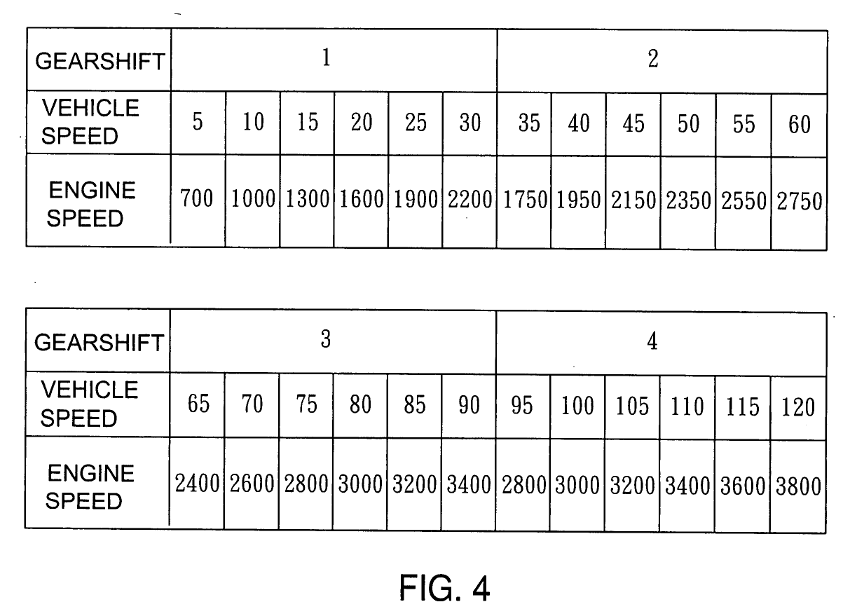

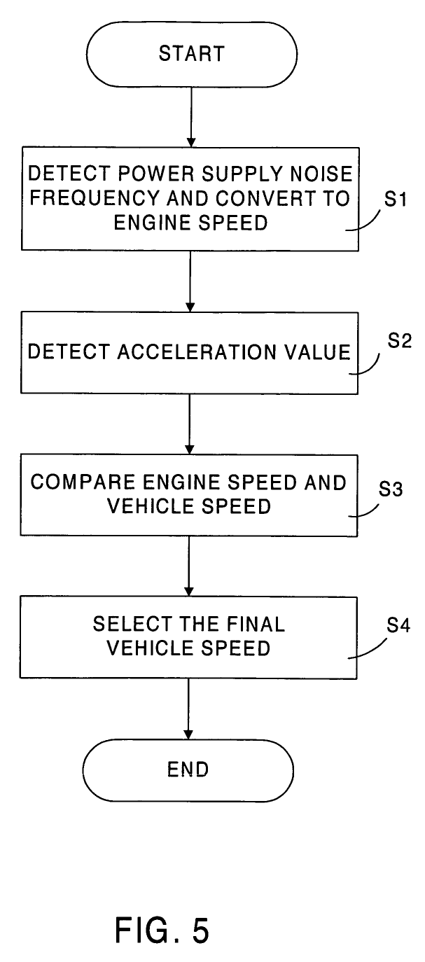

The vehicle speed detection apparatus 2 is plugged into a vehicle lighter jack 3 and is connected to a navigation apparatus 4 to get the NF signals of the vehicle power supply, and convert to engine speed (ES). After incorporating with the acceleration value a, and processed by the processing unit 211, an estimated final vehicle speed V is obtained to be used by the navigation apparatus 4. The procedure is as follow (referring to FIG. 5):
1. Detect the power supply noise frequency and convert to engine speed (step S1): Detect the power supply noise frequency NF by the power supply noise detection unit 21, and convert to the engine speed ES.
2. Detect the acceleration value (step S2): Process and get a second estimated vehicle speed V2 based on the acceleration value a detected by the accelerometer 22.
3. Compare the engine speed and vehicle speed (step S3): Establish a vehicle speed table (referring to FIG. 4) based on comparison of the engine speed ES and a first estimated vehicle speed V1 of a GPS, and modify according to the gearshift to get a third estimated vehicle speed V3.
4. Select a final vehicle speed (step S4): Based on satellite signal receiving conditions and vehicle speed comparison results, estimate and select the final vehicle speed V.

By means of the step S4 mentioned above, the final vehicle speed V is obtained and provided to the navigation apparatus 4 to perform navigation function.

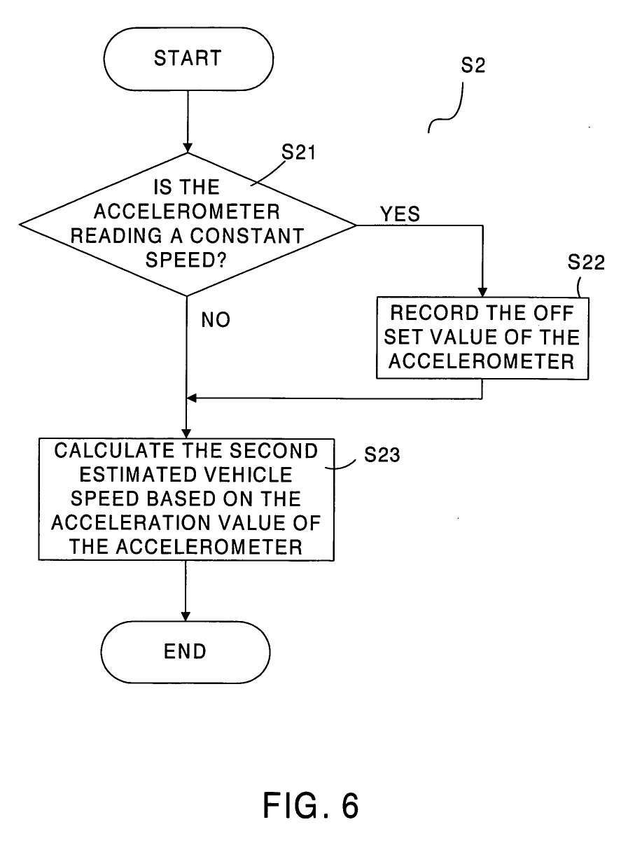

Referring to FIGS. 5 and 6, to execute the step S2, first determine whether the reading of the accelerometer 22 is a constant speed (step 21), namely to judge by the acceleration value a. In the event that the reading of the accelerometer 22 is smaller than a set value a0 (such as the set value is 15 or less), and in a set time period T0 (such as three seconds), it may be determined that the vehicle is not accelerated, and is at a constant speed condition. The processing unit 211 records the off set value of the accelerometer 22, and execute step S22 to be used in the process of compare the engine speed and vehicle speed (Step S3). On the other hand, if the reading exceeds the set value a0 and not reach the set time period T0, it is determined not in a constant speed condition; then a second estimated vehicle speed V2 is derived based on the acceleration value a of the accelerometer 22 to provide the processing unit 211 to do process and comparison (step S23).

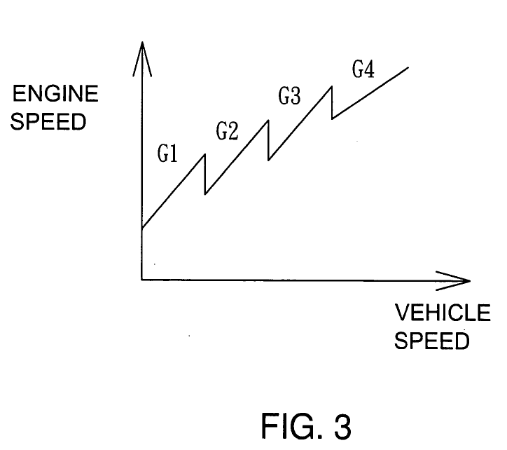

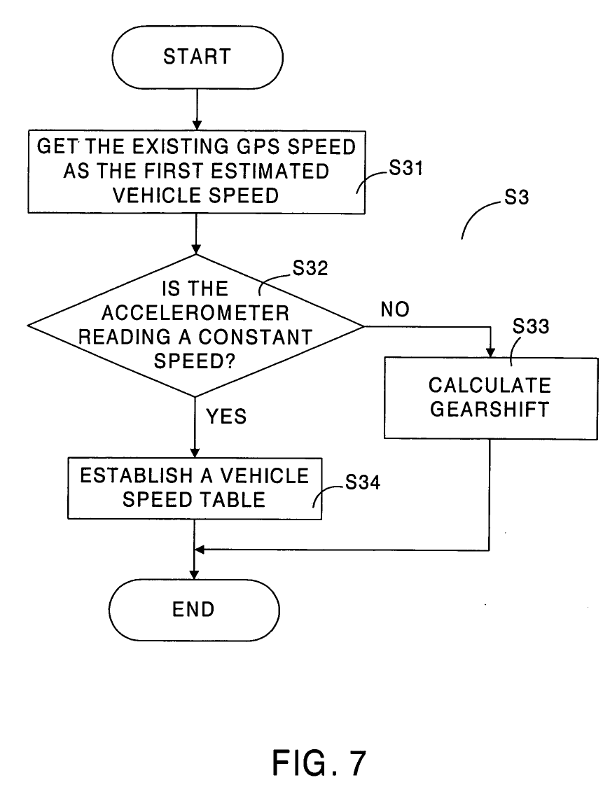

Referring to FIG. 7, at the step S3, in the condition of GPS signals are received (step S31), if the acceleration value a is within the range of a set value a0, it is considered the constant speed (step S32), the relationship of the engine speed ES and the first GPS estimated vehicle speed V1 (namely the current speed supplied by the GPS), besides parking and acceleration and deceleration during gearshift, the engine speed ES and the first estimated vehicle speed V1 form a plurality of non-consecutive constant ratios. Based on this relationship, when the satellite signal condition is desirable, the first estimated vehicle speed V1 may be measured accurately. With the accelerometer 22 measured that the vehicle is not accelerating (namely at a constant speed condition), the relationship between the first estimated vehicle speed V1 and the engine speed ES is a non-continuous straight line (as shown in FIG. 3). It means that when the vehicle gearshift is from gearshift 1 to gearshift 4, the first estimated vehicle speed V1 and the engine speed ES form respectively a constant ratio relationship of G1, G2, G3 and G4. Hence the records of the GPS first estimated vehicle speed V1 and the engine speed ES value may be entered into the statistical data. A plurality of engine speed values (such as two to six times, depending on actual requirements) in the data at the same vehicle speed may be captured for averaging. The resulting average value is included in the vehicle speed table (step S34) to derive a third estimated vehicle speed V3. In the event that the acceleration value a exceeds the set value a0, it indicates that the vehicle is not at a constant speed condition (step S31), and there is a difference between the actual vehicle speed and the second estimated vehicle speed V2, and a modification for a different gearshift is needed (step S33). When the gearshift changes, the engine speed ES rises abruptly then drops, or drops abruptly and rises, then the acceleration and deceleration of accelerometer 22 may be used to determine whether gearshift has actually happened. And the driving gearshift may be determined, and the third estimated vehicle speed V3 may be derived by referring to the vehicle speed table of the corresponding gearshift (step S34).

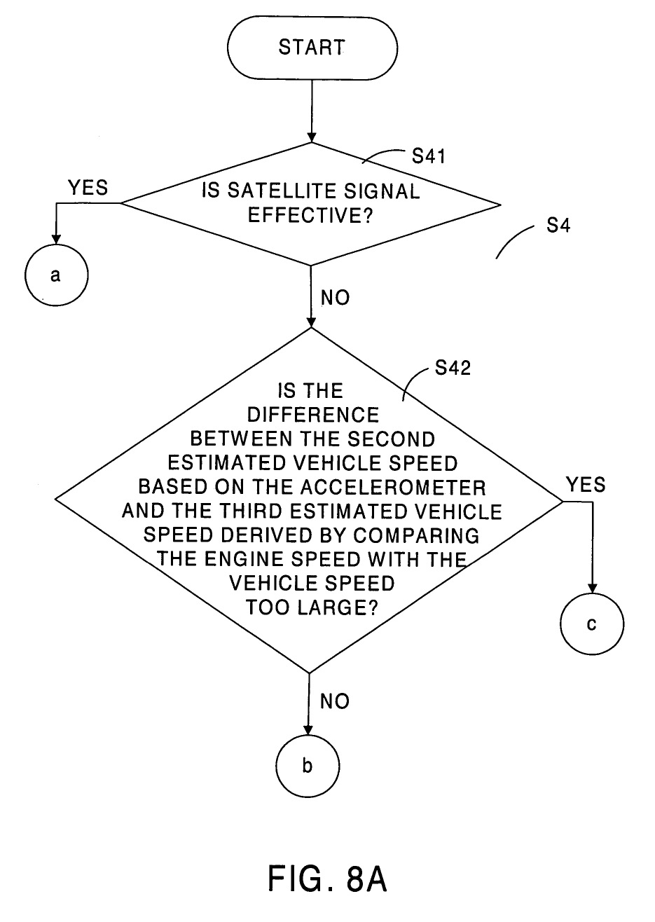

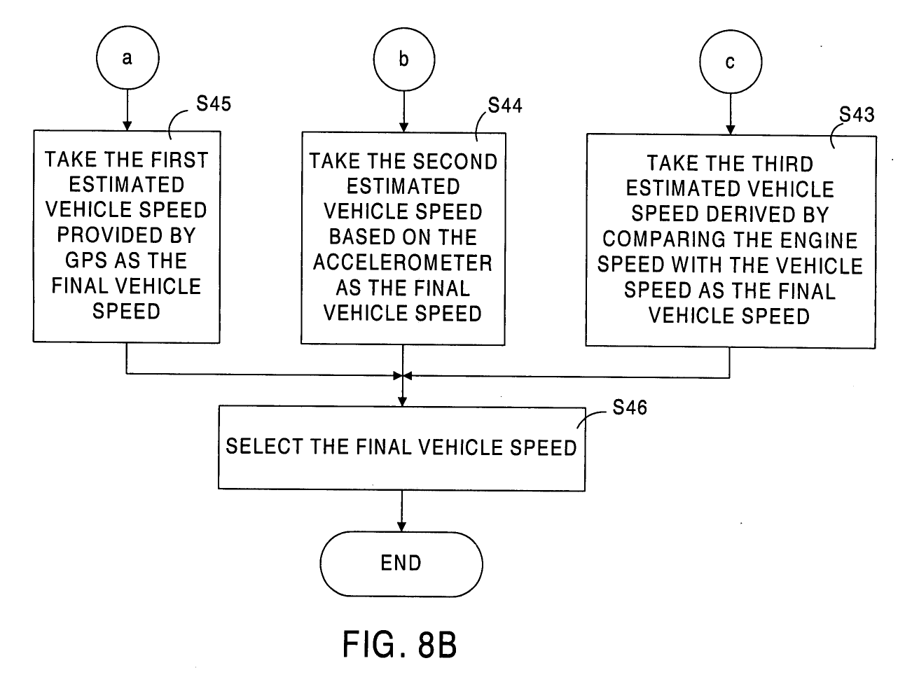

Referring to FIGS. 8A and 8B, at the step S4, the process includes: (1) when the satellite signals are received in a normal condition, the first estimated vehicle speed V1 obtained from the GPS is selected as the final vehicle speed V (steps S41, S45 and S46); (2) when the satellite signals are lost, if the difference X between the second estimated vehicle speed V2 derived from the acceleration speed a of the accelerometer 22 and the third estimated vehicle speed V3 derived by comparing and processing the engine speed and vehicle speed is within a set range (such as 15%, or other value according to requirements), the second estimated vehicle speed V2 calculated by the accelerometer 22 is selected as the final vehicle speed V (steps S41, S42, S44 and S46); (3) if the satellite signals are lost, and the difference X between the second estimated vehicle speed V2 derived from the acceleration speed a of the accelerometer 22 and the third estimated vehicle speed V3 derived by comparing and processing the engine speed and vehicle speed exceeds a set range, the three estimated vehicle speed V3 derived by comparing and processing the engine speed and vehicle speed is selected as the final vehicle speed (step S41, S42, S43 and S46). The selected vehicle speed at the steps S45, S44 and S43 is the final selected vehicle speed V for navigation process (step S5).

I claim:

1. A method for detecting vehicle speed, comprising the steps of:
(1) detecting power supply noise frequency and converting to an engine speed through a vehicle power supply noise detection unit of a vehicle speed detection apparatus;
(2) detecting an acceleration value through an accelerometer and processing to get a second estimated vehicle speed;
(3) comparing the engine speed with a first estimated vehicle speed of GPS to establish a vehicle speed table after having incorporated gearshift modifications to derive a third estimated vehicle speed; and
(4) selecting a final vehicle speed based on satellite signal receiving conditions and the comparison result of the engine speed with the vehicle speed.

2. The method of claim 1, wherein the vehicle speed detection apparatus includes a processing unit which records an off set value of the accelerometer when the accelerometer is at a constant speed.

3. The method of claim 1, wherein the step of comparing the engine speed with a first estimated vehicle speed of GPS includes recording the first estimated vehicle speed and the engine speed value into a statistical data when GPS signals are received and the reading of the accelerometer is a constant speed.

4. The method of claim 3, wherein the engine speed value is an average of a plurality of engine speed values of a same vehicle speed, the average being used to check against a vehicle speed table to derive the third estimated vehicle speed.

5. The method of claim 1, wherein the step of comparing the engine speed with a first estimated vehicle speed of GPS includes processing gearshift calculation when GPS signals are received and the reading of the accelerometer is not a constant speed.

6. The method of claim 5, wherein the processing of gearshift calculation determines gearshift by acceleration and deceleration of the accelerometer and comparing with a vehicle speed on the vehicle speed table on a corresponding gearshift to derive the third estimated vehicle speed.

7. The method of claim 1, wherein the step of selecting a final vehicle speed selects the first estimated vehicle speed obtained through the GPS as the final vehicle speed when the satellite signal is received.

8. The method of claim 1, wherein the step of selecting a final vehicle speed selects the second estimated vehicle speed derived by the accelerometer as the final vehicle speed when the satellite signal is lost and the difference between the second estimated vehicle speed and the third estimated vehicle speed derived by comparing the engine speed and the vehicle speed is within a set range.

9. The method of claim 1, wherein the step of selecting a final vehicle speed selects the third estimated vehicle speed derived by comparing the engine speed and the vehicle speed as the final vehicle speed when the satellite signal is lost and the difference between the second estimated vehicle speed and the third estimated vehicle speed exceeds a set range.

10. The method of claim 1, wherein the selected final vehicle speed at the step of selecting a final vehicle speed is provided to a navigation apparatus to perform navigation function.
